(19) United States
(12) Patent Application Publication
(10) Pub. No.: US 2015/0269366 A1
(43) Pub. Date: Sep. 24, 2015

(54) SYSTEM AND METHOD FOR DIGITAL RIGHTS MANAGEMENT

(71) Applicant: BlackBerry Limited, Waterloo (CA)

(72) Inventor: Matthew BELLS, Waterloo (CA)

(21) Appl. No.: 14/716,762

(22) Filed: May 19, 2015

Related U.S. Application Data
(62) Division of application No. 10/739,719, filed on Dec. 18, 2003.

(51) Int. Cl. G06F 21/10; G06F 11/14

(52) U.S. Cl. CPC G06F 21/105; G06F 11/1402; G06F 11/1451

(57) ABSTRACT

Methods and systems for handling a plurality of digital assets on a mobile device, wherein backups of the plurality of digital assets are created so as conform to digital rights management issues. Encrypted versions and/or links of the plurality of digital assets may be stored so that the mobile device or other electronic devices may access the backups.

### BACKGROUND

1. Technical Field

The present invention relates generally to the field of communications, and in particular to handling data on mobile wireless communications devices.

2. Description of the Related Art

Data capabilities on mobile wireless communications devices (“mobile devices”) have significantly increased over time. However, the increased data capabilities have also generated concerns over how to handle data in view of digital rights management issues. Digital rights management seeks to protect digital assets and control the distribution and usage of those digital assets. Accordingly, balancing the need for greater data handling capabilities with the needs of digital rights management have led to difficulties as to how data can be effectively and efficiently backed up, copied, edited, or otherwise handled on mobile devices.

### SUMMARY

Methods and systems are provided for handling a plurality of digital assets on a wireless mobile communications device, wherein backups of the plurality of digital assets are created so as conform to digital rights management issues. Encrypted versions and/or links of the plurality of digital assets may be stored so that the mobile device or other electronic devices may access the backups. A data structure may be used to specify the format of the backups.

Data to and from the mobile device may be transmitted through data signals, such as those embodied on carrier waves or other media. Computer-readable media, such as volatile and non-volatile storage mechanisms, may be used to store computer instructions for implementing the systems and methods disclosed herein.

As will be appreciated, the invention is capable of other and different embodiments, and its several details are capable of modifications in various respects, all without departing from the spirit of the invention. Accordingly, the drawings and description set forth below are to be regarded as illustrative in nature and not restrictive.

### BRIEF DESCRIPTION OF THE DRAWINGS

FIG. 1 is an overview of an example communication system in which a wireless communication device may be used.

FIG. 2 is a block diagram of a system that performs backup operations of digital assets.

FIG. 3 is a block diagram of a system that performs backup and restoring operations of digital assets.

FIG. 4 is a block diagram of a system that allows other mobile devices to access a digital asset via a backup.

FIG. 5 is a flowchart depicting steps for performing backups of digital assets.

FIG. 6 is a block diagram depicting the use of links in backing up digital assets.

FIG. 7 is a block diagram depicting the use of encryption techniques in generating backups of digital assets.

FIG. 8 is a block diagram depicting the use of secure interfaces in accessing backups of digital assets.

FIG. 9 is a data structure diagram depicting a digital asset backup data structure.

FIG. 10 depicts data fields in an example of a digital asset backup data structure.

FIG. 11 depicts an example of data fields and values of a digital asset backup data structure.

FIG. 12 is a block diagram of an example mobile device.

### DETAILED DESCRIPTION OF THE DRAWINGS

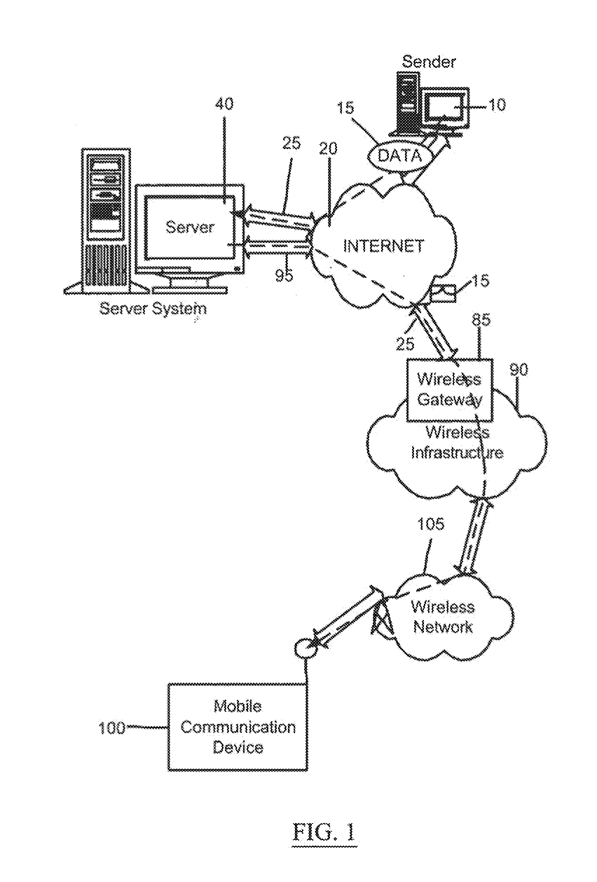

FIG. 1 is an overview of an example communication system in which a wireless communication device may be used. One skilled in the art will appreciate that there may be hundreds of different topologies, but the system shown in FIG. 1 helps demonstrate the operation of the approaches described herein. There may also be many senders and recipients. The system shown in FIG. 1 is for illustrative purposes only, and shows an Internet e-mail environment where security is not generally used.

FIG. 1 shows a data sender 10, the Internet 20, a server system 40, a wireless gateway 85, wireless infrastructure 90, a wireless network 105 and a mobile communication device 100.

A sender system 10 may, for example: be connected to an ISP (Internet Service Provider), such as America Online (AOL), on which a user of the system 10 has an account; located within a company, possibly connected to a local area network (LAN), and connected to the Internet 20; or connected to the Internet 20 through an ASP (application service provider). Those skilled in the art will appreciate that the systems shown in FIG. 1 may instead be connected to a wide area network (WAN) other than the Internet, although e-mail transfers are commonly accomplished through Internet-connected arrangements as shown in FIG. 1.

The server 40 may be implemented, for example, on a network computer within the firewall of a corporation, a computer within an ISP or ASP system or the like, and acts as the main interface for e-mail exchange over the Internet 20. Although other systems might not require a server system 40, a mobile device 100 configured for receiving and possibly sending data will normally be associated with an account on a server. Perhaps the two most common servers are Microsoft Exchange™ and Lotus Domino™. These products are often used in conjunction with Internet routers that route and deliver mail and other data. Server 40 may extend beyond just e-mail sending and receiving; they also include dynamic database storage engines that have predefined database formats for data like calendars, to-do lists, task lists, e-mail and documentation as well as having voice and phone capabilities.

The wireless gateway 85 and infrastructure 90 provide a link between the Internet 20 and wireless network 105. The wireless infrastructure 90 determines the most likely network for locating a given user and tracks the user as they roam between countries or networks. Data is then delivered to the mobile device 100 via wireless transmission, typically at a radio frequency (RF), from a base station in the wireless network 105 to the mobile device 100. The particular network 105 may be virtually any wireless network over which data may be exchanged with a mobile communication device.

Regardless of the specific mechanism controlling the forwarding of data to the mobile device 100, the sender's data 15, or possibly a translated or reformatted version thereof, is sent to the wireless gateway 85. The wireless infrastructure 90 includes a series of connections to wireless network 105. These connections could be Integrated Services Digital Network (ISDN), Frame Relay or T1 connections using the TCP/IP protocol used throughout the Internet. As used herein, the term “wireless network” is intended to include (but is not limited to) three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Division Multiple Access (CDMA) networks, (2) Groupe Special Mobile or Global System for Mobile Communications (GSM) and General Packet Radio Service (GPRS) networks, and (3) future third-generation (3G) networks like Enhanced Data-rates for GSM Evolution (EDGE) and Universal Mobile Telecommunications Systems (UMTS). Some older examples of data-centric networks include the Mobitex™ Radio Network and the DataTAC™ Radio Network. Examples of older voice-centric data networks include Personal Communication Systems (PCS) networks like GSM, and TDMA systems.

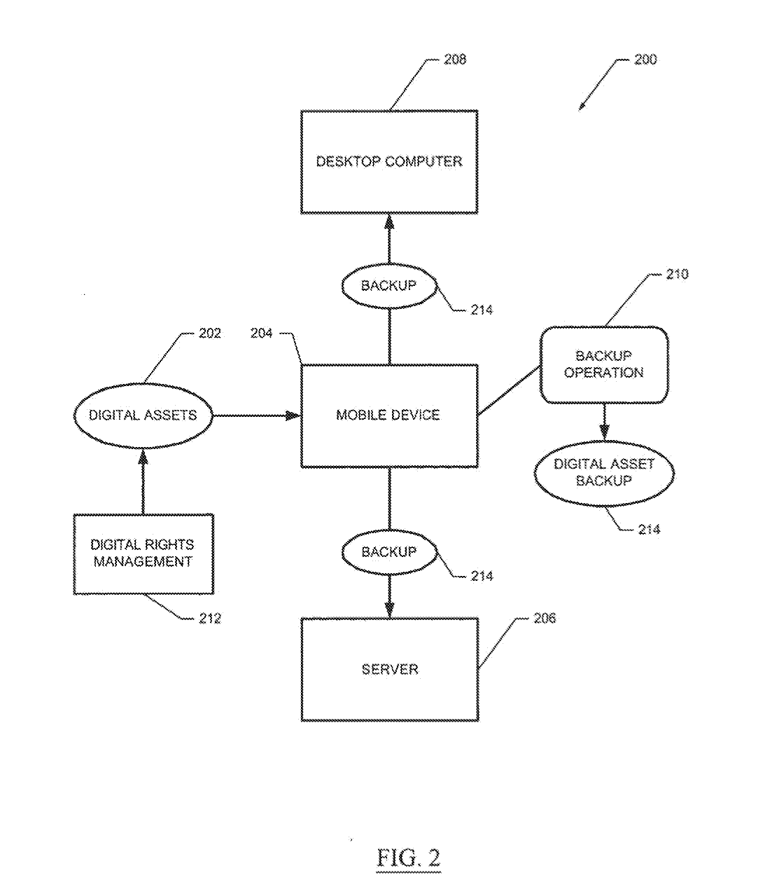

FIG. 2 depicts a system 200 that allows backups of digital assets 202 on a mobile device 204 in a manner that addresses digital rights management and/or other data handling issues. A mobile device 204 can receive a digital asset (e.g., bitmap image, song, ring tone, software such as in games and other types of software, electronic book, video, etc.) from many different sources, such as from a download via a company's website.

The download may be subject to licensing terms that dictate how digital rights 212 should be managed on the mobile device 204 with respect to the downloaded digital asset 202. The mobile device is configured such that a backup operation 210 is performed without allowing a digital asset backup 214 to be viewed, played or otherwise activated. The digital asset backup 214 may be stored either in a remote archive or as another instance on the mobile device 204.

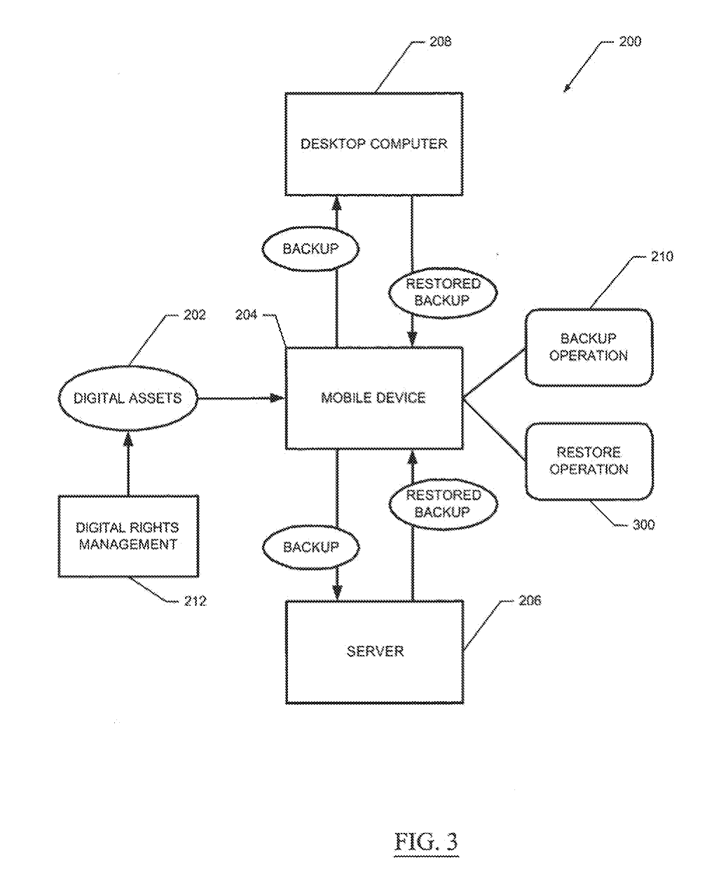

The backup of digital assets 202 is useful in many different situations. As shown for example in FIG. 3, a user may wish to perform a restore operation 300 in order to restore to the mobile device 204 a digital asset lost due to a device malfunction or unavailable for another reason. A restoring of the digital asset may be performed under a number of situations, such as automatically performing a restore operation 300 upon power up of the mobile device 204. The backup may be stored locally on the mobile device 204, remotely on a server 206 or desktop computer 208, or both; and hence recoverable from a source that has the backup.

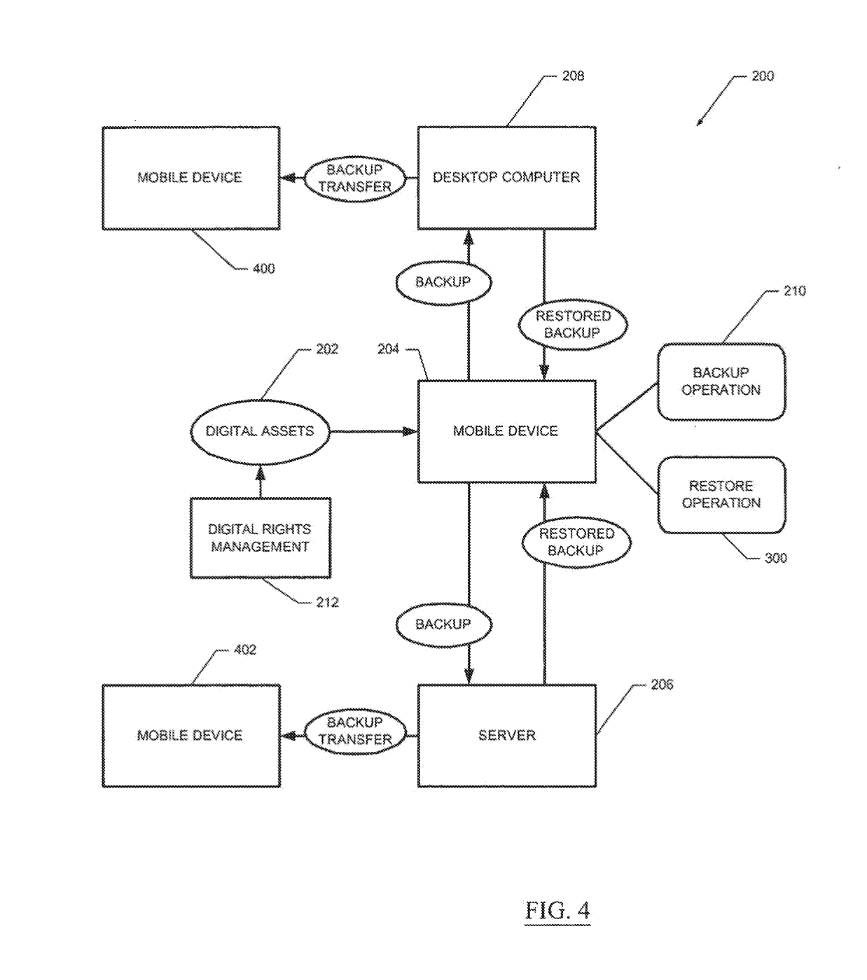

However, it should be understood that many other uses may be made of the backup system 200. For example, FIG. 4 shows other mobile devices (400, 402) being able to access the digital asset backup without allowing the digital asset backup to be viewed, played or otherwise activated by the mobile devices (400, 402), thereby continuing to conform to the restrictions imposed on the digital asset by digital rights management. The mobile device 204 may be configured with the capability of designating which other mobile devices (e.g., 400, 402) are allowed to restore or access a digital asset backup.

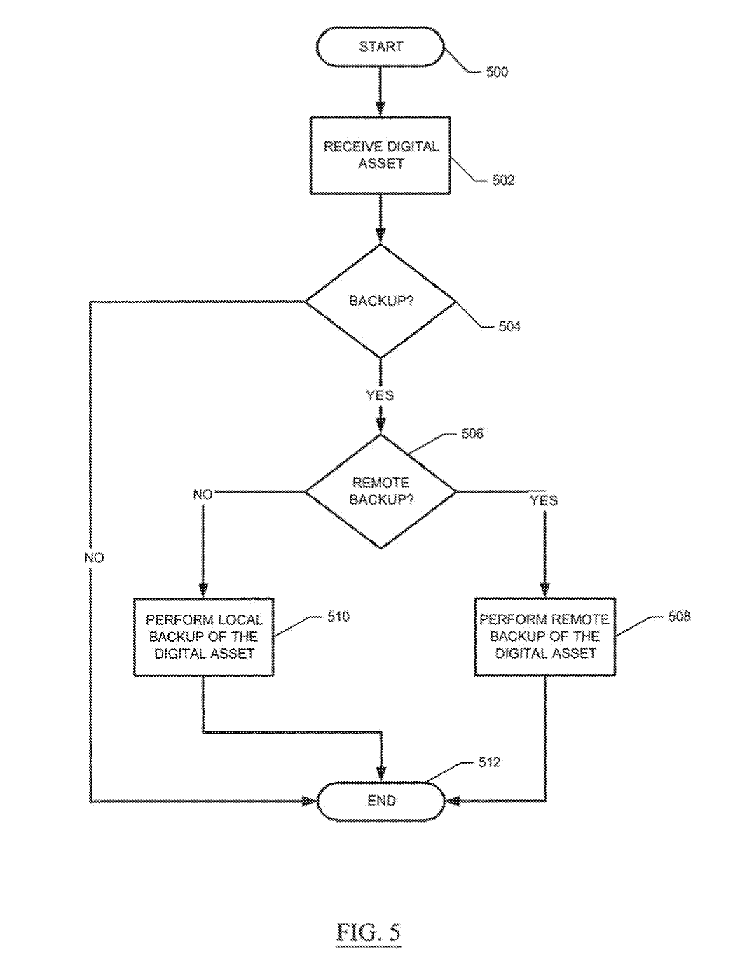

FIG. 5 depicts steps for backing up digital assets on a mobile device. Start block 500 indicates that at step 502, a digital asset is received by the mobile device. As described above, the digital asset can be downloaded to the mobile device over a wireless network. The digital asset can also be downloaded from the user's desktop computer (such as through an infrared port, a communications cable, or a cradle) or from a storage device that can be attached to or inserted into the mobile device.

If a backup is to be performed as determined by decision step 504, then processing continues at decision step 506, else backup processing ends at end block 512. Decision step 504 may decide to perform a backup due to the user specifying that a backup of the digital asset is to be automatically performed. The backup may also be performed for other reasons, such as automatically backing up digital assets as they are loaded onto the mobile device.

If processing continues at decision step 506, then it is determined whether a remote backup is desired. This determination may be based on such factors as whether a connection to the remote system is available.

If a remote backup is not to be performed as determined by decision step 506, then step 510 performs a local backup of the digital asset without allowing the backup to be viewed, played or otherwise activated. However if a remote backup is to be performed, then the backup of the digital asset is sent to the remote system. Processing then ends at end block 512.

It should be understood that the steps in the flowchart need not necessarily include all of the steps disclosed herein and may include further steps and operations in addition thereto. For example, decision step 506 may be omitted if the mobile device only wishes to locally backup digital assets or wishes to only remotely backup digital assets. As another example, a mobile device may elect to both locally and remotely backup a digital asset.

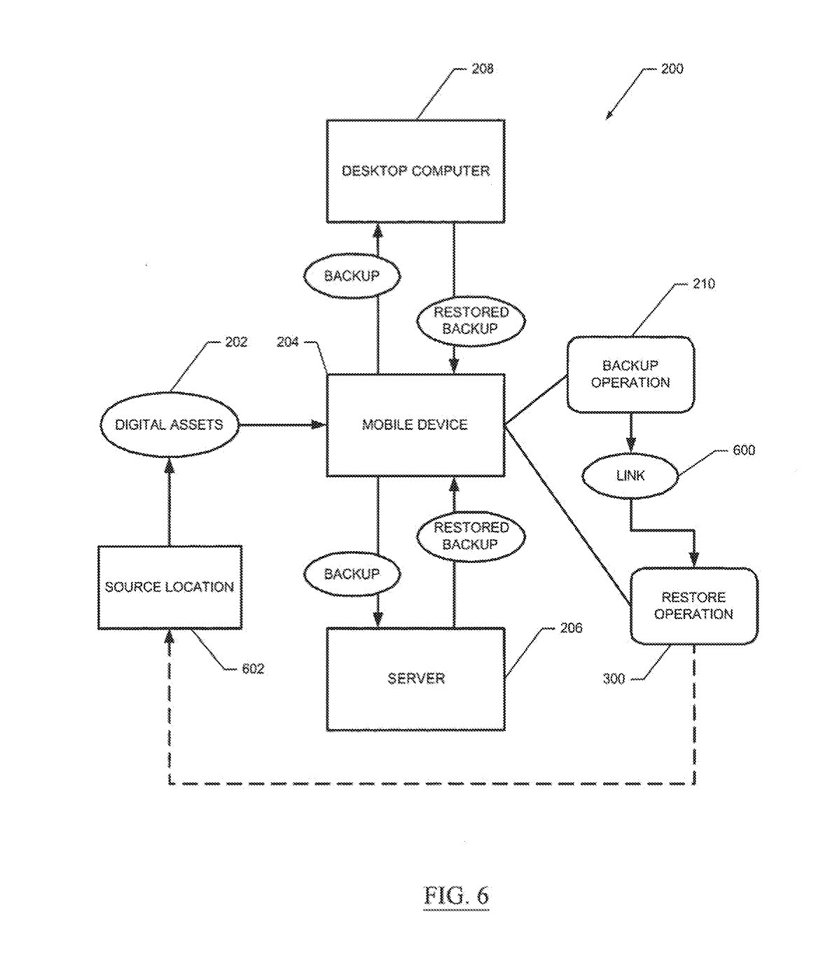

As shown in FIG. 6, a backup may be performed by storing as the backup a link 602 to the remote source location 602 of the digital asset 202. The link 602 (e.g., reference) can be backed up locally and/or remotely. If the digital asset needs to be restored to the mobile device 204 or otherwise accessed, then the mobile device 204 uses a restore operation 300 to locate the digital asset via the link 600 and restore the digital asset to the mobile device 204.

The backup operation 210 may happen automatically when the digital asset is loaded onto the mobile device 204, such as through a copy-paste operation into a document of the mobile device 204. If a link 600 is a URL (uniform resource locator) such as to a web page on a vendor's website, the backup operation 210 may include storing the original URL with each download of media content.

A link 600 as a backup is useful to send information to someone. For example, a user could send an e-mail containing the link 600 saying “Here is that ringtone you have been looking for: <link>.” The recipient would click on the link 600, confirm payment, and download the content.

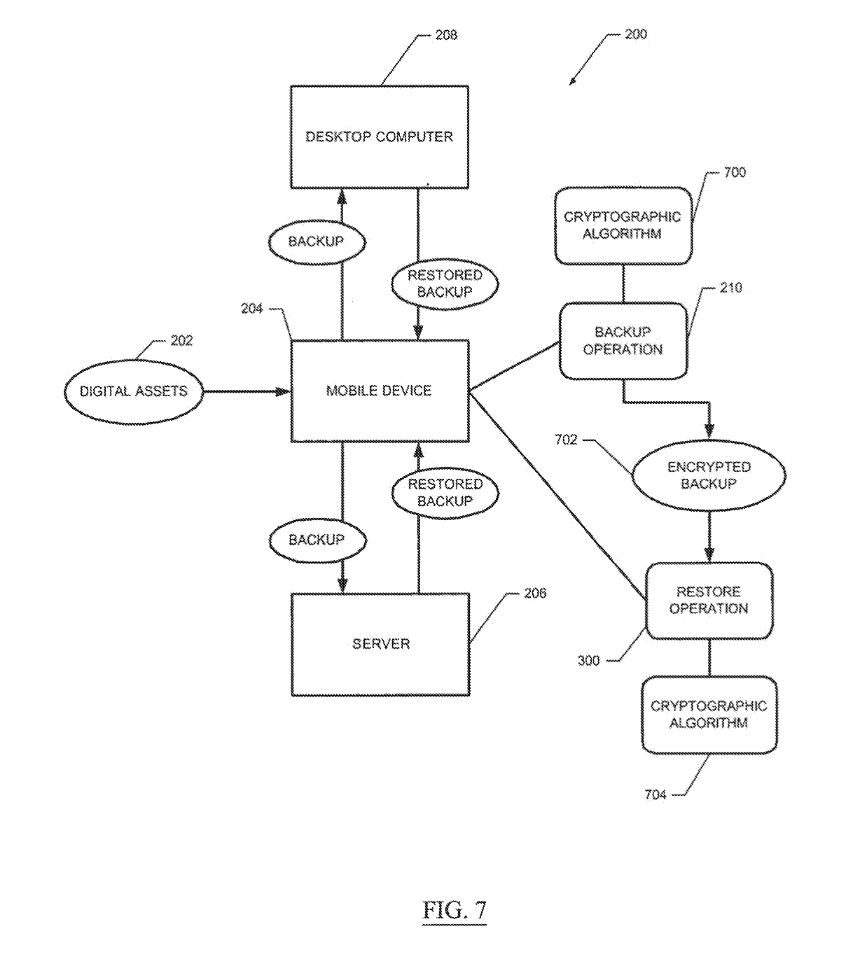

Other backup approaches may be used. For example as shown in FIG. 7, the safe and managed digital asset storage system 200 could be extended physically and logically from the mobile device 204 by way of cryptographic techniques, wherein the backup operation 210 encrypts a copy of the digital asset through a cryptographic algorithm 700 in order to create an encrypted backup 702. Cryptographic algorithms 700, such as those available in the cryptography toolkit provided by the assignee of this application, may be used for the backup operation. One such cryptographic algorithm that may be used is the AES (Advanced Encryption Standard) cryptographic algorithm.

The cryptographic algorithm 700 uses information not readily knowable by others to encrypt a backup copy of the digital asset, thereby limiting the user's and other's capability to access and effectively distribute the digital asset. For example, the data could be encrypted with user specific data, preventing such a compromise. Still further the cryptographic algorithm 700 can use information not only relatively or easily unknowable by others, but also not knowable by the user of the mobile device 204. As an illustration, the mobile device's SIM (subscriber identity module) card information or hash thereof may be used for the key by the cryptographic algorithm 700. As another example, the multi-digit IMSI (International Mobile Subscriber Identity) number and/or IMEI (International Mobile Equipment Identity) number could be used as the key. These pieces of information are not generally visible to the user, and can be used as secret data in the backup encryption operations. A cryptographic hash of one or more of these identity data items may be used as an additional security measure since this information itself is also used for encrypting information with the SIM card. Additionally, if the SIM card information is used, then this would allow the user to switch devices and maintain their data more easily.

Other examples include: using any non-transferable and non-replicable and sufficiently unique data or hash thereof for a key in the backup encryption operations; using an internal device serial number or hash thereof for a key; randomly assigning a key and writing it to a SIM card file; using any of the aforementioned techniques to encrypt a random key that encrypted the data (e.g., use of a session key); using combinations, either in serial or in parallel, as the key (e.g., this would allow extensions such as “usable by the same device OR the same SIM card”); and/or using secret data stored on a company infrastructure server. This last approach may facilitate escrow access, and is typically better at storing larger amounts of secret data than the mobile device 204, especially if key length becomes insufficient. This might be useful for enterprises that require the ability to search data to comply with regulations.

The backup operation may create the backup on receipt of the content. This prevents switching the SIM card and sending it to another mobile device if so desired. It is noted that the data of the digital asset may be internally cached in an unencrypted form, thereby allowing for faster access.

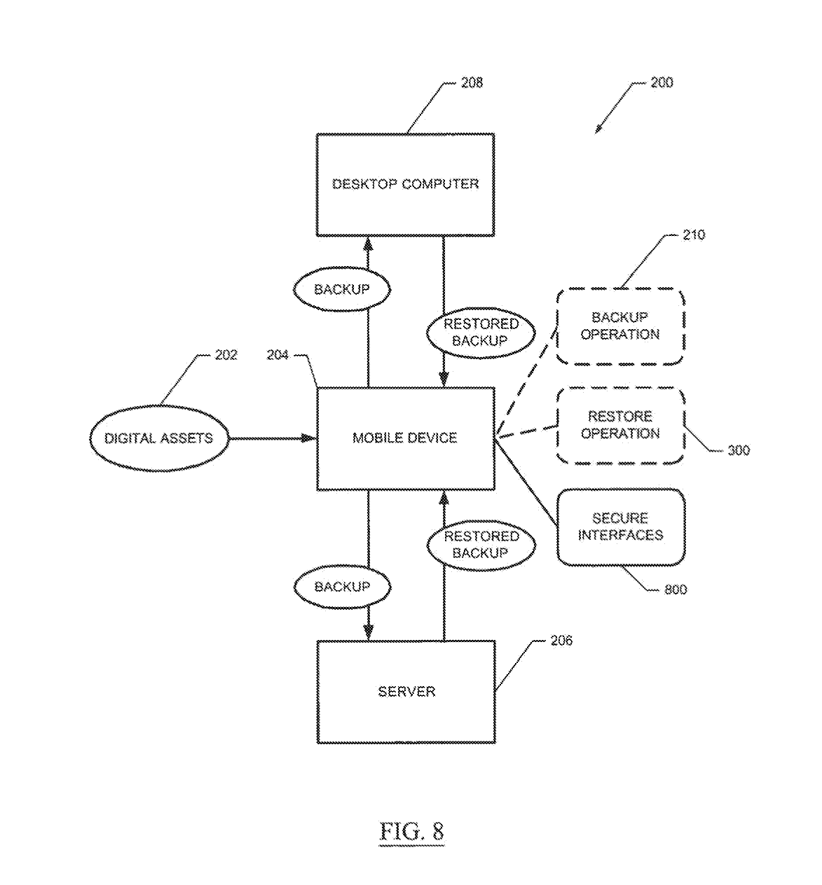

FIG. 8 illustrates another approach to handling digital assets 202 on a mobile device 204. In addition to or in replacement of the backup/restoring operations (210, 300), the mobile device 204 can provide secure interfaces 800 to the digital assets 202 downloaded to the mobile device 204. In this example, an application is able to reference a sound file (e.g., a MIDI file) and play it without being able to access the bytes of the sound file. This can be done by interposing the secure interface between the digital asset and the application. A secure interface, such as the Java MMAPI interface, may be used whereby an insecure or untrusted application may request a digital asset be accessed, for example a piece of music. The secure implementation would verify the asset may be accessed on the particular mobile device. The untrusted application could not access, and hence expropriate, the digital data but would only have access to general information such as the duration or amount of visual space required. As another example, an image file could be displayed without being able to access individual pixel information or copy it anywhere other than the screen.

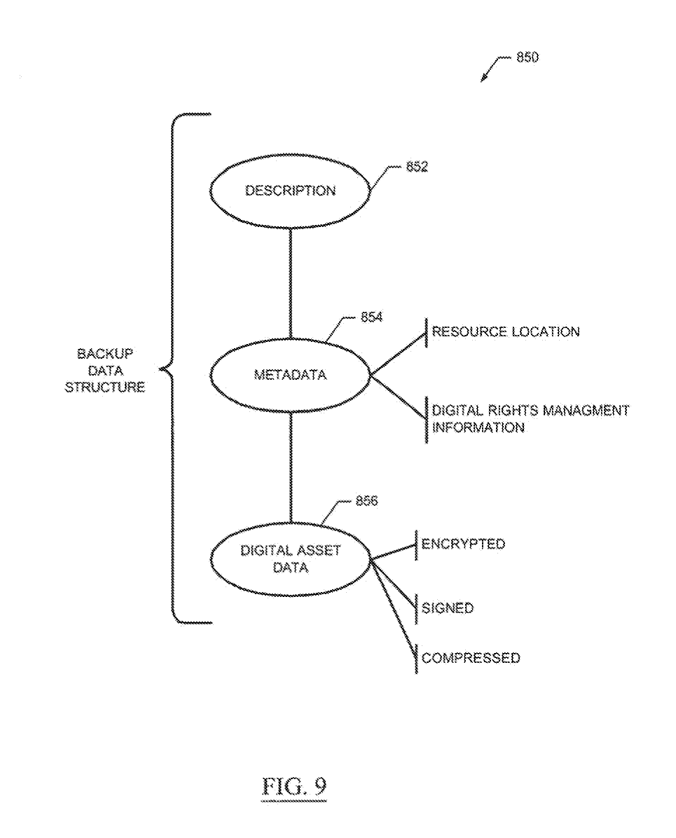

FIG. 9 shows at 850 a data structure as an example of a backup storage format for use with the methods and systems disclosed herein. The backup data structure 850 illustrated in FIG. 9 includes a description portion 852 for storing information about how the data of the digital asset is being protected, such as information about the key used to encrypt the data. A metadata portion 854 stores information about the digital asset. This may include restrictions on use of the digital asset, copyright notices, location of the digital asset, etc. The metadata portion 854 may be encrypted, or alternatively some or all of the metadata does not have to be encrypted. If desired, it can be protected with a signature. This allows the rights to be viewed. Any packet with an invalid signature could be refused by the mobile device because this provides an indication that a user had tampered with the metadata (e.g., removing or altering the copyright notice). The backup data structure 850 includes a portion 856 to store the digital asset data. Within this portion 856 of the data structure 850, the digital asset data can be encrypted, and if desired, signed and/or compressed.

It should be understood that the backup data structure 850 illustrates a possible format of backup data for storage on computer-readable media and/or in a computer program. A backup data structure 850 may be structured to include more or less information than what is depicted in FIG. 9. For example as depicted in FIG. 9, the backup data structure 850 contains portions that store a link to the original source of the digital asset as well as portions that store an encrypted version of the digital asset. Other backup data structures may be used, such as those that only store the source link, or those that only store the encrypted version, etc.

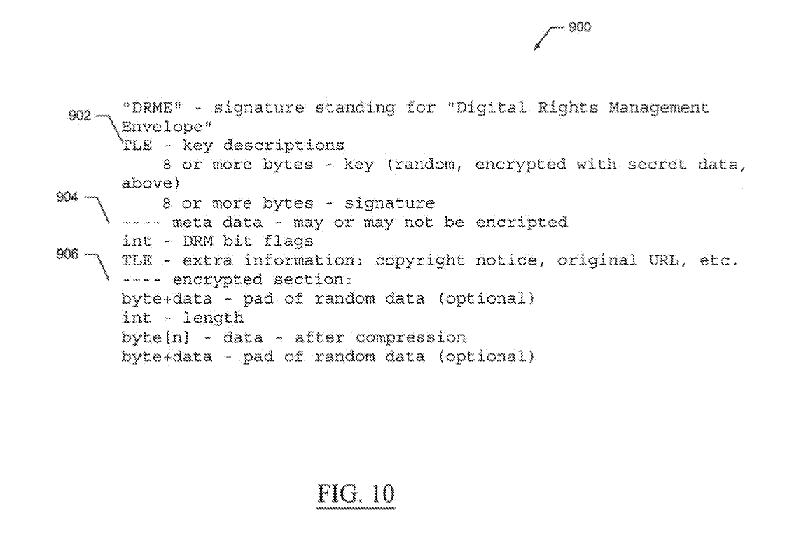

FIG. 10 shows an example of different fields and their formats and lengths for use in backup data structure 900. However, it should be understood that different fields, formats, and lengths may be used while still being usable by the systems and methods disclosed herein.

Section 902 of the data structure 900 includes type length encoded (TLE) fields that hold key descriptions. Eight of more bytes may be used to describe the key which accesses the encrypted digital asset backup. Eight of more bytes may be used to describe the signature of the data structure 900 to ensure its integrity.

Section 904 contains metadata that provides such information as digital rights management (DRM) information. In the metadata portion 904, restriction information can be indicated through bit data. For example, a “deny copy” bit can be set to indicate that a mobile device cannot copy the digital asset. Other information may include the copyright notice associated with the digital asset, the source URL of the digital asset, etc.

Section 906 contains the encrypted backup version of the digital asset. The backup version may also be compressed and digitally signed.

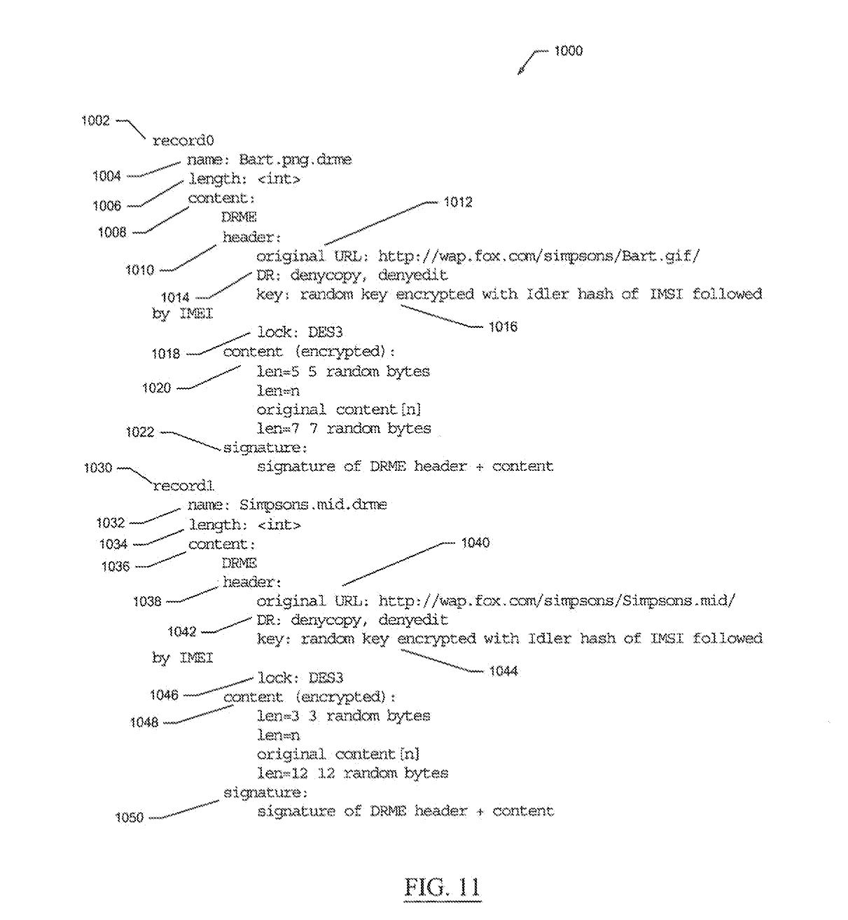

As an illustration of the use of a backup data structure, if a user has paid to use a bit-mapped graphics file (Bart.png) and a sound file (Simpsons.mid), then a backup data structure 1000 and its values could resemble what is shown in FIG. 11. Two records (1002, 1030) of the data structure 1000 contain the two digital assets.

The name of the first record 1002 is provided at field 1004. The name is “Bart.png.drme” wherein the suffix “drme” is an acronym for digital rights management envelope. Field 1006 indicates the length of the record.

The content field 1008 contains such fields as a header field 1010 wherein the original source URL is provided at 1012 for the graphics digital asset. Digital rights, such as deny copying and deny editing, are specified at field 1014. Field 1016 provides a description of the key used to encrypt the graphics digital asset (e.g., random key encrypted with Idler hash of the IMSI identification number followed by the IMEI identification number). Field 1018 provides a description of the lock, which in this example is DES3. The encrypted graphics digital asset is contained at field 1020. The signature is provided at field 1022 and was generated by using the record's header 1010 and the record's content 1020.

The name of the second record 1030 is provided at field 1032 which is “Simpsons.mid.drme”. Field 1034 indicates the length of the second record.

The content field 1036 contains such fields as a header field 1038 wherein the original source URL is provided at 1040 for the sound digital asset. Digital rights, such as deny copying and deny editing, are specified at field 1042. Field 1044 provides a description of the key used to encrypt the graphics digital asset (e.g., random key encrypted with Idler hash of the IMSI identification number followed by the IMEI identification number). Field 1046 provides a description of the lock, which in this example is DES3. The encrypted sound digital asset is contained at field 1048. The signature is provided at field 1050 and was generated by using the record's header 1038 and the record's content 1048.

The systems and methods disclosed herein are presented only by way of example and are not meant to limit the scope of the invention. Other variations of the systems and methods described above will be apparent to those skilled in the art and as such are considered to be within the scope of the invention.

For example, the systems and methods disclosed herein address such digital rights management concerns as the copying, generation of derivative works, performance, licensing, and so forth of digital assets, and they prevent unauthorized access to the digital content as well as limit access to those with proper authorization. The systems and methods may also address other data accessing issues, such as efficiently backing up data on a resource constrained mobile device (e.g., storing only a link to the original and not a complete copy of the digital asset) and/or handling group distribution of data. As an illustration of group distribution of data, a digital asset provider may send to members in a group a link to the digital asset. A member's mobile device then can select when to utilize resources to remotely access the digital asset. Distribution could also be accomplished by distributing encrypted digital assets and then supplying the keys to the recipients needed to access the encrypted digital assets. The keys supplied to each of the recipients could include a session key that has been encrypted by the recipient's public key.

Still further, one or more systems and methods described herein can provide a way in which a mobile device can address digital rights management issues in a different manner than they are addressed by other devices, such as desktop computers, since the digital rights management issues confronted by a mobile device are different from those that are confronted by such other devices. For example, digital asset downloads to mobile devices are typically performed in a different manner than digital asset downloads to desktop computers, and thus the mobile device environment has its own unique digital rights management issues.

As another example, the systems and methods allow for the use of non-volatile protected storage for keys (as opposed to hardware ID), as well as multiple branding (SIM card and device). Also a wide assortment of digital assets may be handled, such as current ringtones, legacy data, idle screens, etc.

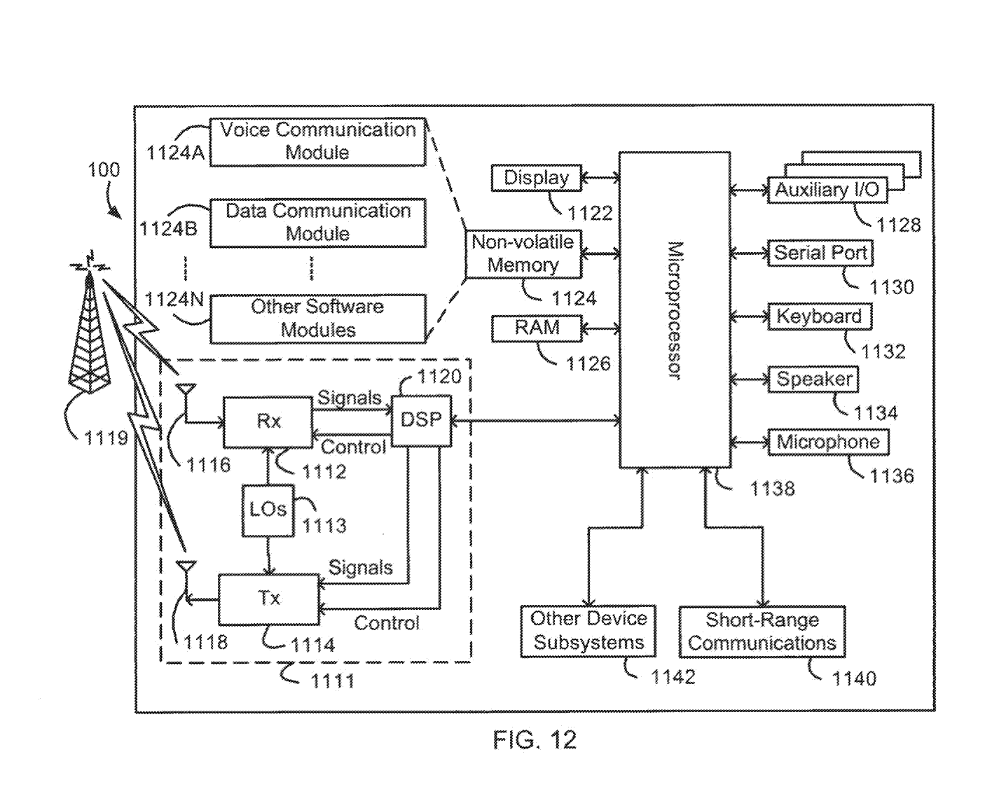

As yet another example, the systems and methods disclosed herein may be used with many different computers and devices, such as a wireless mobile communications device shown in FIG. 12. With reference to FIG. 12, the mobile device 100 is a dual-mode mobile device and includes a transceiver 1111, a microprocessor 1138, a display 1122, non-volatile memory 1124, random access memory (RAM) 1126, one or more auxiliary input/output (I/O) devices 1128, a serial port 1130, a keyboard 1132, a speaker 1134, a microphone 1136, a short-range wireless communications sub-system 1140, and other device sub-systems 1142.

The transceiver 1111 includes a receiver 1112, a transmitter 1114, antennas 1116 and 1118, one or more local oscillators 1113, and a digital signal processor (DSP) 1120. The antennas 1116 and 1118 may be antenna elements of a multiple-element antenna, and are preferably embedded antennas. However, the systems and methods described herein are in no way restricted to a particular type of antenna, or even to wireless communication devices.

The mobile device 100 is preferably a two-way communication device having voice and data communication capabilities. Thus, for example, the mobile device 100 may communicate over a voice network, such as any of the analog or digital cellular networks, and may also communicate over a data network. The voice and data networks are depicted in FIG. 12 by the communication tower 1119. These voice and data networks may be separate communication networks using separate infrastructure, such as base stations, network controllers, etc., or they may be integrated into a single wireless network.

The transceiver 1111 is used to communicate with the network 1119, and includes the receiver 1112, the transmitter 1114, the one or more local oscillators 1113 and the DSP 1120. The DSP 1120 is used to send and receive signals to and from the transceivers 1116 and 1118, and also provides control information to the receiver 1112 and the transmitter 1114. If the voice and data communications occur at a single frequency, or closely-spaced sets of frequencies, then a single local oscillator 1113 may be used in conjunction with the receiver 1112 and the transmitter 1114. Alternatively, if different frequencies are utilized for voice communications versus data communications for example, then a plurality of local oscillators 1113 can be used to generate a plurality of frequencies corresponding to the voice and data networks 1119. Information, which includes both voice and data information, is communicated to and from the transceiver 1111 via a link between the DSP 1120 and the microprocessor 1138.

The detailed design of the transceiver 1111, such as frequency band, component selection, power level, etc., will be dependent upon the communication network 1119 in which the mobile device 100 is intended to operate. For example, a mobile device 100 intended to operate in a North American market may include a transceiver 1111 designed to operate with any of a variety of voice communication networks, such as the Mobitex or DataTAC mobile data communication networks, AMPS, TDMA, CDMA, PCS, etc., whereas a mobile device 100 intended for use in Europe may be configured to operate with the GPRS data communication network and the GSM voice communication network. Other types of data and voice networks, both separate and integrated, may also be utilized with a mobile device 100.

Depending upon the type of network or networks 1119, the access requirements for the mobile device 100 may also vary. For example, in the Mobitex and DataTAC data networks, mobile devices are registered on the network using a unique identification number associated with each mobile device. In GPRS data networks, however, network access is associated with a subscriber or user of a mobile device. A GPRS device typically requires a subscriber identity module (“SIM”), which is required in order to operate a mobile device on a GPRS network. Local or non-network communication functions (if any) may be operable, without the SIM device, but a mobile device will be unable to carry out any functions involving communications over the data network 1119, other than any legally required operations, such as ‘911’ emergency calling.

After any required network registration or activation procedures have been completed, the mobile device 100 may the send and receive communication signals, including both voice and data signals, over the networks 1119. Signals received by the antenna 1116 from the communication network 1119 are routed to the receiver 1112, which provides for signal amplification, frequency down conversion, filtering, channel selection, etc., and may also provide analog to digital conversion. Analog to digital conversion of the received signal allows more complex communication functions, such as digital demodulation and decoding to be performed using the DSP 1120. In a similar manner, signals to be transmitted to the network 1119 are processed, including modulation and encoding, for example, by the DSP 1120 and are then provided to the transmitter 1114 for digital to analog conversion, frequency up conversion, filtering, amplification and transmission to the communication network 1119 via the antenna 1118.

In addition to processing the communication signals, the DSP 1120 also provides for transceiver control. For example, the gain levels applied to communication signals in the receiver 1112 and the transmitter 1114 may be adaptively controlled through automatic gain control algorithms implemented in the DSP 1120. Other transceiver control algorithms could also be implemented in the DSP 1120 in order to provide more sophisticated control of the transceiver 1111.

The microprocessor 1138 preferably manages and controls the overall operation of the mobile device 100. Many types of microprocessors or microcontrollers could be used here, or, alternatively, a single DSP 1120 could be used to carry out the functions of the microprocessor 1138. Low-level communication functions, including at least data and voice communications, are performed through the DSP 1120 in the transceiver 1111. Other, high-level communication applications, such as a voice communication application 1124A, and a data communication application 1124B may be stored in the non-volatile memory 1124 for execution by the microprocessor 1138. For example, the voice communication module 1124A may provide a high-level user interface operable to transmit and receive voice calls between the mobile device 100 and a plurality of other voice or dual-mode devices via the network 1119. Similarly, the data communication module 1124B may provide a high-level user interface operable for sending and receiving data, such as e-mail messages, files, organizer information, short text messages, etc., between the mobile device 100 and a plurality of other data devices via the networks 1119.

The microprocessor 1138 also interacts with other device subsystems, such as the display 1122, the RAM 1126, the auxiliary input/output (I/O) subsystems 1128, the serial port 1130, the keyboard 1132, the speaker 1134, the microphone 1136, the short-range communications subsystem 1140 and any other device subsystems generally designated as 1142.

Some of the subsystems shown in FIG. 12 perform communication-related functions, whereas other subsystems may provide “resident” or on-device functions. Notably, some subsystems, such as the keyboard 1132 and the display 1122 may be used for both communication-related functions, such as entering a text message for transmission over a data communication network, and device-resident functions such as a calculator or task list or other PDA type functions.

Operating system software used by the microprocessor 1138 is preferably stored in a persistent store such as non-volatile memory 1124. The non-volatile memory 1124 may be implemented, for example, as a Flash memory component, or as battery backed-up RAM. In addition to the operating system, which controls low-level functions of the mobile device 1110, the non-volatile memory 1124 includes a plurality of software modules 1124A-1124N that can be executed by the microprocessor 1138 (and/or the DSP 1120), including a voice communication module 1124A, a data communication module 1124B, and a plurality of other operational modules 1124N for carrying out a plurality of other functions. These modules are executed by the microprocessor 1138 and provide a high-level interface between a user and the mobile device 100. This interface typically includes a graphical component provided through the display 1122, and an input/output component provided through the auxiliary I/O 1128, keyboard 1132, speaker 1134, and microphone 1136. The operating system, specific device applications or modules, or parts thereof, may be temporarily loaded into a volatile store, such as RAM 1126 for faster operation. Moreover, received communication signals may also be temporarily stored to RAM 1126, before permanently writing them to a file system located in a persistent store such as the Flash memory 1124.

An exemplary application module 1124N that may be loaded onto the mobile device 100 is a personal information manager (PIM) application providing PDA functionality, such as calendar events, appointments, and task items. This module 1124N may also interact with the voice communication module 1124A for managing phone calls, voice mails, etc., and may also interact with the data communication module for managing e-mail communications and other data transmissions. Alternatively, all of the functionality of the voice communication module 1124A and the data communication module 1124B may be integrated into the PIM module.

The non-volatile memory 1124 preferably also provides a file system to facilitate storage of PIM data items on the device. The PIM application preferably includes the ability to send and receive data items, either by itself, or in conjunction with the voice and data communication modules 1124A, 1124B, via the wireless networks 1119. The PIM data items are preferably seamlessly integrated, synchronized and updated, via the wireless networks 1119, with a corresponding set of data items stored or associated with a host computer system, thereby creating a mirrored system for data items associated with a particular user.

Context objects representing at least partially decoded data items, as well as fully decoded data items, are preferably stored on the mobile device 100 in a volatile and non-persistent store such as the RAM 1126. Such information may instead be stored in the non-volatile memory 1124, for example, when storage intervals are relatively short, such that the information is removed from memory soon after it is stored. However, storage of this information in the RAM 1126 or another volatile and non-persistent store is preferred, in order to ensure that the information is erased from memory when the mobile device 100 loses power. This prevents an unauthorized party from obtaining any stored decoded or partially decoded information by removing a memory chip from the mobile device 100, for example.

The mobile device 100 may be manually synchronized with a host system by placing the device 100 in an interface cradle, which couples the serial port 1130 of the mobile device 100 to the serial port of a computer system or device. The serial port 1130 may also be used to enable a user to set preferences through an external device or software application, or to download other application modules 1124N for installation. This wired download path may be used to load an encryption key onto the device, which is a more secure method than exchanging encryption information via the wireless network 1119. Interfaces for other wired download paths may be provided in the mobile device 100, in addition to or instead of the serial port 1130. For example, a USB port would provide an interface to a similarly equipped personal computer.

Additional application modules 1124N may be loaded onto the mobile device 100 through the networks 1119, through an auxiliary I/O subsystem 1128, through the serial port 1130, through the short-range communications subsystem 1140, or through any other suitable subsystem 1142, and installed by a user in the non-volatile memory 1124 or RAM 1126. Such flexibility in application installation increases the functionality of the mobile device 100 and may provide enhanced on-device functions, communication-related functions, or both. For example, secure communication applications may enable electronic commerce functions and other such financial transactions to be performed using the mobile device 100.

When the mobile device 100 is operating in a data communication mode, a received signal, such as a text message or a web page download, is processed by the transceiver module 1111 and provided to the microprocessor 1138, which preferably further processes the received signal in multiple stages as described above, for eventual output to the display 1122, or, alternatively, to an auxiliary I/O device 1128. A user of mobile device 100 may also compose data items, such as e-mail messages, using the keyboard 1132, which is preferably a complete alphanumeric keyboard laid out in the QWERTY style, although other styles of complete alphanumeric keyboards such as the known DVORAK style may also be used. User input to the mobile device 100 is further enhanced with a plurality of auxiliary I/O devices 1128, which may include a thumbwheel input device, a touchpad, a variety of switches, a rocker input switch, etc. The composed data items input by the user may then be transmitted over the communication networks 1119 via the transceiver module 1111.

When the mobile device 100 is operating in a voice communication mode, the overall operation of the mobile device is substantially similar to the data mode, except that received signals are preferably be output to the speaker 1134 and voice signals for transmission are generated by a microphone 1136. Alternative voice or audio I/O subsystems, such as a voice message recording subsystem, may also be implemented on the mobile device 100. Although voice or audio signal output is preferably accomplished primarily through the speaker 1134, the display 1122 may also be used to provide an indication of the identity of a calling party, the duration of a voice call, or other voice call related information. For example, the microprocessor 1138, in conjunction with the voice communication module and the operating system software, may detect the caller identification information of an incoming voice call and display it on the display 1122.

A short-range communications subsystem 1140 is also included in the mobile device 100. The subsystem 1140 may include an infrared device and associated circuits and components, or a short-range RF communication module such as a Bluetooth™ module or an 802.11 module, for example, to provide for communication with similarly-enabled systems and devices. Those skilled in the art will appreciate that “Bluetooth” and “802.11” refer to sets of specifications, available from the Institute of Electrical and Electronics Engineers, relating to wireless personal area networks and wireless local area networks, respectively.

1. A method for handling a plurality of digital assets on a mobile device, comprising the steps of:
creating backups of the plurality of digital assets by creating, on the mobile device, encrypted versions of the plurality of digital assets;
accessing the encrypted version of a digital asset in order to restore the digital asset for use on the mobile device;
creating backups of the plurality of digital assets by automatically storing, on the mobile device, references to locations where the plurality of digital assets are accessible:
wherein the locations are remote locations with respect to the mobile device;
accessing one of the stored references in order to restore a digital asset for use on the mobile device.

2. (canceled)

3. The method of claim 1, wherein the backups of the plurality of digital assets are performed in a manner that addresses issues of digital rights management.

4. The method of claim 3, wherein digital rights management is directed to protecting digital assets and control the distribution and usage of those digital assets.

5. The method of claim 4, wherein digital rights management is directed to how data can be backed up, copied, or edited on a mobile device.

6. The method of claim 1, wherein the plurality of digital assets include audio digital assets, video digital assets, software, graphics digital assets, or combinations thereof.

7. The method of claim 1, wherein the plurality of digital assets are downloaded from a website in an unencrypted form.

8. The method of claim 7, wherein the downloads of the plurality of digital assets are subject to licensing terms, wherein the licensing terms are directed to digital rights management.

9. The method of claim 1, wherein the backups are created such that the backups are not capable of being viewed or played on another mobile device without a restore operation being performed.

10. The method of claim 1, wherein the backups are created such that the backups are not capable of being viewed or played on the mobile device without a restore operation being performed.

11. The method of claim 10, wherein the restore operation conforms to digital rights management licensing terms stipulated by the owners of the plurality of digital assets.

12. The method of claim 10, further comprising the step of performing a restore operation in order to restore to the mobile device a digital asset lost due to a mobile device malfunction.

13. The method of claim 10, further comprising the step of performing a restore operation automatically upon power up of the mobile device.

14. The method of claim 10, wherein another electronic device uses one of the digital asset backups in order to load a digital asset onto the other electronic device.

15. The method of claim 14, wherein the loading of the digital asset onto the other electronic device conforms to digital rights management licensing terms stipulated by the owner of the digital asset.

16. The method of claim 14, wherein the mobile device designates which other electronic devices are permitted to use the digital asset backups in order to acquire digital assets.

17. The method of claim 1, wherein the creating of a digital asset backup is automatically performed upon download of a digital asset to the mobile device.

18. The method of claim 1, wherein the backups are stored on a remote computer system, wherein the remote computer system includes means for recovering the backup for use on the mobile device.

19. The method of claim 1, wherein the backups are stored on the mobile device.

20. The method of claim 1, wherein a digital asset backup is stored both on a remote computer system and on the mobile device.

21-24. (canceled)

25. The method of claim 1, wherein secret data stored on a company infrastructure server is used to create an encrypted version of a digital asset.

26. The method of claim 1, further comprising the step for creating encrypted versions of the digital assets.

27. The method of claim 1, further comprising the step of using a secure interface that is interposed between a digital asset and an application which requires activation of the digital asset;
wherein the application is not permitted to access the digital asset directly but may access the digital asset except through the secure interface.

28. The method of claim 1, wherein the digital asset backups are used in handling group distribution of data.

29. The method of claim 1, wherein the mobile device is a handheld wireless mobile communications device.

30. The method of claim 1, wherein the mobile device is a notebook computer.

31. The method of claim 1, wherein the mobile device is a personal digital assistant (PDA).

32-33. (canceled)

34. A non-transitory computer-readable medium storing computer-readable code executable by a processor of a mobile device to cause the mobile device to perform the method of claim 1.

35. A method for handling a plurality of digital assets on a mobile device, comprising the steps of:
creating backups of the plurality of digital assets by automatically storing, on the mobile device, references to locations where the plurality of digital assets are accessible;
wherein the locations are remote locations with respect to the mobile device;
accessing one of the stored references in order to restore a digital asset for use on the mobile device.

36. The method of claim 35, wherein the references to locations are address locations for locating the digital assets on a network.

37. The method of claim 36, wherein the references are Uniform Resource Locator (URL) links.

38. The method of claim 37, wherein the links as backups are stored remotely from the mobile device.

39. The method of claim 37, wherein the links as backups are stored locally on the mobile device.

40. The method of claim 37, wherein the links as backups are stored remotely from the mobile device and are stored locally on the mobile device.

41. The method of claim 37, further comprising the step of using one of the links to restore the digital asset to the mobile device.

42. The method of claim 37, further comprising the step of using one of the links to provide the digital asset to another mobile device.

43. A mobile device that handles backups of digital assets, comprising:
a backup module that is configured to store backups of a plurality of digital assets in a backup data structure;
wherein the backup data structure is configured to store encrypted versions of the plurality of digital assets;
wherein the backup data structure is configured to be accessible by the mobile device in order to access the encrypted version of the digital asset stored in the backup data structure;
wherein the backups are stored so as to comply with one or more digital rights management requirements;
wherein the backup data structure is configured to store references to locations where the plurality of digital assets are accessible:
wherein the locations are remote locations with respect to the mobile device;
wherein the backup data structure is configured to be accessible by a mobile device in order to access one of the stored references in order to restore a digital asset for use on the mobile device.

44. The mobile device of claim 43, further comprising:
means for creating encrypted versions of the plurality of digital assets.

45. (canceled)

46. The mobile device of claim 43, wherein the backup module comprises instructions to store the backups of the plurality of digital assets in a backup data structure.

47. The mobile device of claim 43, wherein the backup data structure includes a key descriptions section, a metadata section, and an encrypted section;
wherein the key descriptions section is for storing encrypted key information and signature key information;
wherein the metadata section is for storing digital rights management information;
wherein the encrypted section is for storing an encrypted version of a digital asset.
